(19) United States
(12) Patent Application Publication
(10) Pub. No.: US 2008/0143741 A1
(43) Pub. Date: Jun. 19, 2008

(54) METHOD AND APPARATUS FOR DISPLAYING CHARACTER STRING

(76) Inventors: Zhen Huang, Beijing (CN); Yan Liu, Beijing (CN); Rui Feng, Beijing (CN)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 11/945,571

(22) Filed: Nov. 27, 2007

(30) Foreign Application Priority Data
Nov. 28, 2006 (CN) 200610162760.8

(51) Int. Cl. G09G 5/00

(52) U.S. Cl. 345/619

(57) ABSTRACT

A method and an apparatus are provided for displaying a character string when the character string is being input. The method includes: grouping a plurality of positions for inputting characters into a plurality of position groups; configuring display format of the characters to be input for every position group; and responding to input of the character string, displaying the input character string with the configured display format. The methods and apparatus will facilitate a user reading character strings, and verifying character strings while inputting them.

### CROSS-REFERENCES TO RELATED APPLICATIONS

This application is related to Chinese Patent Application No. 200610162760.8, filed Nov. 28, 2006.

### FIELD OF THE INVENTION

The present invention relates to character string processing technology, more particularly, relates to method and apparatus for inputting and displaying a character string with a plurality of digits or characters.

### BACKGROUND OF THE INVENTION

Presenting computers and computing apparatus with computing functions are becoming more and more popular. Sometimes people need to input or read a long character string, such as an ID number, which is composed of an 18 digit number, or cell phone number, which is composed of an 11 digit number. Inputting or reading such a long character string is unpleasant and easy to make mistakes.

In the prior art, the following methods are usually used to handle long character strings. For example, when handling serial number, IP address or credit card number, use several text boxes to divide the string into several parts and limit the number of characters in each box. Other examples include currency, such as $234,567.00 use some separators such as comma to divide the numbers.

The drawback of the above known methods is that a whole value has to be divided into several parts, which restricts further processing of these digits. For example, people cannot use copy-paste to input the whole string in at one time, or the separators such as a comma are also copied and pasted.

### SUMMARY OF THE INVENTION

In view of the shortcoming of the prior art, the present invention provides a method for displaying a character string when the character string is being input, including: grouping a plurality of positions for inputting characters into a plurality of position groups; configuring display format of the characters to be input for every position group; and responding to input of the character string, displaying the input character string with the configured display format.

The present invention also provides a method for displaying a character string, including: grouping a character string to be displayed into a plurality of character groups; configuring display format for every character group; and displaying the character string with the configured display format.

The present invention also provides an apparatus for displaying a character string when the character string is being input, including: grouping means, for grouping a plurality of positions for inputting characters into a plurality of position groups; format configuring means, for configuring display format of the characters to be input for every position group; and displaying means, for displaying the input character string with the configured display format, in response to input of the character string.

The present invention also provides an apparatus for displaying a character string, including: grouping means, for grouping a character string to be displayed into a plurality of character groups; format configuring means, for configuring display format for every character group; and displaying means, for displaying the character string with the configured display format.

The methods and apparatus will facilitate a user reading character strings, and verifying character strings while inputting them.

### BRIEF DESCRIPTION OF THE DRAWINGS

FIG. 1 is a flow chart according to one embodiment of the present invention.

FIG. 2 is another flow chart according to another embodiment of the present invention.

### DETAILED DESCRIPTION

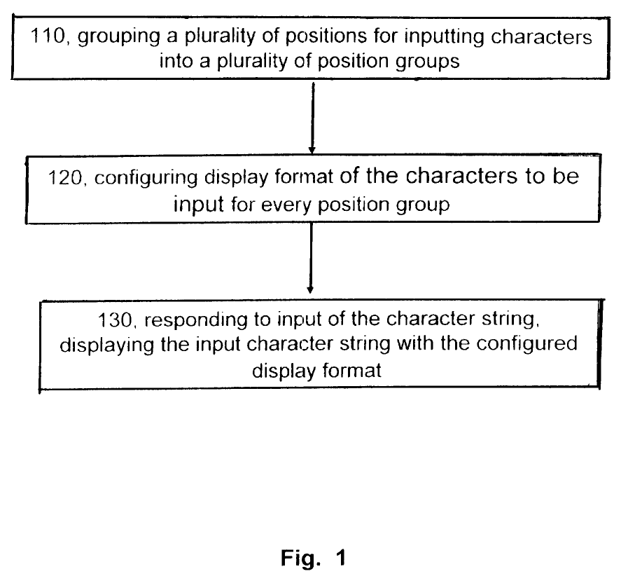

FIG. 1 is a flow chart according to one embodiment of the present invention. FIG. 1 illustrates a method for displaying a character string when the character string is being input. The method includes: at step 110, grouping a plurality of positions for inputting characters into a plurality of position groups; at step 120, configuring display format for every position group for the characters to be input; and at step 130, responding to input of the character string, displaying the input character string with the configured display format.

Wherein, at steps 120 and 130, at least two display formats of the characters to be input can be configured for at least two position groups, and circularly using the display format of the at least two position groups. The plurality of positions for inputting a character string could be located in a user interface.

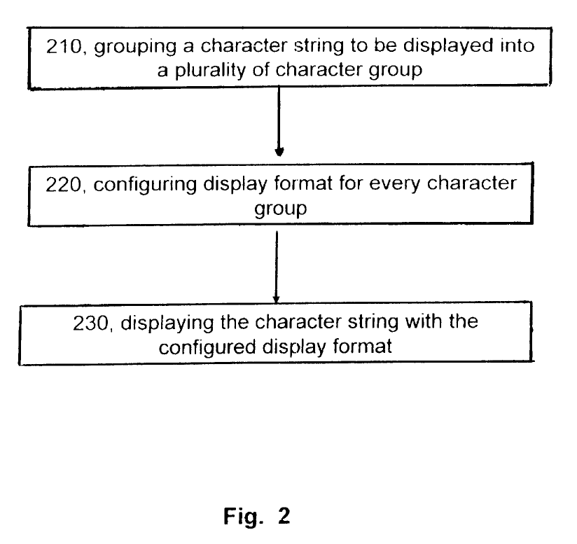

FIG. 2 is another flow chart according to another embodiment of the present invention. FIG. 2 shows a method for displaying a character string. The method includes: at step 210, grouping a character string to be displayed into a plurality of character groups; at step 220, configuring a display format for every character group; and at step 230, displaying the character string with the configured display format.

Wherein, at steps 220 and 230, at least two display formats of the characters to be input can be configured for at least two position groups, and the at least two display formats will be circularly used in the at least two position groups. The plurality positions for inputting a character string could be located in a user interface.

In the present invention, a sequence of a character string could include a plurality of characters or numbers, e.g. abcqrs, 123456 or abc123qrs456. Wherein, the format for every several characters or numbers is changed, e.g. the font, color, or size, etc. is changed. The rules for setting the format of characters or numbers of the character string might be created. The rules for setting the format of characters or numbers of the string might be configured according to the meaning of the numbers or characters.

According to one aspect of the present invention, the strings are easy to input and read after its format is configured. Therefore, the string is easy to be verified at the same time of being input. Copy and paste can be used to input or process the string.

In one embodiment of the present invention, the format for every several digits in an input interface is preset, e.g. the font, size or color is preset. When a user inputs digits, the input digits are immediately displayed in the preset format. Thus, verifying input becomes easy, and input could be done quickly and correctly. Even if a mistake occurs during input, the mistake is easy to be checked.

In another embodiment of the present invention, a control is used to set the format of digits. The control includes the following parameters:
Intervals: to specify where to change mode
Mode: a combination of one or more formats
For example, the format of a string of digits is set as following.

intervals={number1, number2, ..., numberi}={1,4,8}
modei={font=fontname,size=sizenumber,color=colorname}
mode1={font=Times New Roman, size=10, color=Blue}
mode2={font=Times New Roman, size=12, color=Black}
mode3={font=Times New Roman, size=10, color=Red}

The format of the first 3 digits in the string is model={font=Times New Roman, size=10, color=Blue}. The format of the 4^{th} to 7^{th} digits is mode2={font=Times New Roman, size=12, color=Black}. The format of the 8^{th} to 11^{th} digits is mode3={font=Times New Roman, size=10, color=Red}.

It could be understood by a person skilled in the art that the control may have default settings for formats. If more than one mode is specified in the control, the modes could be used circularly. For example, if intervals={1,4,8}*, the “*” could be used to present that mode1, mode2 and mode3 of above control are set to be used circularly. If the number of digits in a digital string is more than 11, the 12^{th} to 14^{th} digit use model, the 15^{th} to 18^{th} digit use mode2, and 19^{th} to 22^{nd} digit use mode3, etc.

The following is an embodiment to refresh the displays by the control

if (the value of input changed)
{

scan the input characters
for (each character)

set the font, size and color for this character

refresh the display

}
......
<object classid=″CLSID:THECLASSIDNUMBER″ class=″OBJECT
″id=“LongValue″ ><param
name=″intevals″ intervals={1,3,7,11,15,18}″><param name=″mode1″
value=″{font=” Arial” ;size=10;(color=red}″><param name=″mode2″
value=″{font=” Times New Roman” ;size=16;color=blue}″></object>
......

The following embodiments will illustrate how the formats of Chinese ID number, cell phone number and password are processed.

The ID number in China is composed of 18 digits, for example, 110105198001010014. Every digit in the ID number is not an isolated digit. Digit or digits have special meaning and are related to other digits.

Part 1 includes the 1st to 6th digit. Part 1 represents address code, indicating the province/city/district code, according to GB/T 2260 code standard.

Part 2 includes the 7th to 14th digit. Part 2 represents birthday code, its format is YYYYMMDD.

Part 3 includes the 15th to 17th digit. Part 3 represents serial number. An odd number in the 17th digit means a male, even number means a female.

Part 4 includes the 18th digit. Part 4 is check digit, according to ISO 7064: 1983, MOD 11-2 standard.

The parameters of the control for the format of the ID number are set as following.

intervals={1,3,7,11,15,18}
mode1={font=Arial;size=10;color=red}
mode2={font=Times New Roman; size=16;color=blue}

When ID 110105198001010014 is being input, it will be displayed as following. The format for 11, 1980, 001 includes: font is Arial, size is 10, color is red; The format for 0105, 0101 and 4 includes: font is Times New Roman, size is 16, and color is blue.

₁₁0105₁₉₈₀0101₀₀₁4

The above method makes it easy for the ID numbers to be input, read and validated.

Cell phone number, like 13610555678 also has a special meaning for every several digits. The first 3 digits indicate the countrywide cell phone service provider. China Unicom uses 130-134 and China Mobile uses 135-139. The 4th to 7th digits indicate the district cell phone service provider. The last 4 digits is a serial number to distinguish different user.

The parameters of the control for the format of the cell phone number could be set as following:

intervals={1,4,8}
mode1={color=red}
mode2={color=blue}
mode3={color=black}

Then the cell phone number is display as 13610555678. Wherein, 136 is blue, 1055 is red and 5678 is black.

For the pre-pay cell phone, people need to charge money before using it. Normally a user will get a meaningless 18-digit password by buying a phone card from the internet. Then, the user needs to call a service phone number and input this password to charge for the cell phone.

The following is a password example which a user bought from the internet The password is 013212283532170874. It is really hard for the user to read it from his laptop as well as input into the cell phone.

For these meaningless numbers, we can simply change the formats for every 4 digits. By this way, the user can easily read and input this number. For example, intervals={*4},mode1={color=blue}. Then, 0132 will be blue, 1228 will be black, 3532 will be blue, 1708 will be black, 74 will be blue.

The present invention also provides a storage medium or signal carrier including instructions for carrying out the method of the present invention.

The preferred embodiments of the present invention have been described in detail. However, one skilled in the art will realize that the preferred embodiments are only given for the purpose of illustration, and should not be construed as limiting the present invention thereto. This invention can be implemented by way of software, hardware or the combination of the two. One skilled in the art can make various modifications and variations to the present invention, however, these modifications and variations are all within the scope and spirit of the invention as defined in the accompanying claims.

1. A method for displaying a character string when the character string is being input, comprising:
a) grouping a plurality of positions for inputting characters into a plurality of position groups;
b) configuring display format for every position group for the characters to be input; and
c) responding to input of the character string, displaying the input character string with the configured display format.

2. The method according to claim 1, wherein the steps of configuring display format for every position group for the characters to be input and responding to input of the character string, displaying the input character string with the configured display format, comprise configuring display format of the characters to be input for at least two position groups, and circularly using the display format configured for the at least two position groups.

3. The method according to claim 1, wherein the plurality of positions for inputting character strings are located in a user interface.

4. The method according to claim 1, wherein said character string comprises a composition of a plurality of digits and/or alphabetic characters.

5. A method for displaying a character string, comprising:
a) grouping a character string to be displayed into a plurality of character groups;
b) configuring display format for every character group; and
c) displaying the character string with the configured display format.

6. The method according to claim 5, wherein the steps of configuring display format for every character group and displaying the character string with the configured display format comprise configuring display format for at least two character groups, and circularly using the display format configured for the at least two character groups.

7. The method according to claim 5, wherein positions for displaying the character string are located in a user interface.

8. The method according to claim 5, wherein said character string comprises a composition of a plurality of digits and/or alphabetic characters.

9. An apparatus for displaying a character string when the character string is being input, comprising:
grouping means, for grouping a plurality of position for inputting characters into a plurality of position groups;
format configuring means, for configuring display format of the characters to be input for every position group; and
displaying means, for displaying the input character string with the configured display format in response to input of the character string.

10. The apparatus according to claim 9, wherein the format configuring means and the displaying means is further configured to configure the display format of the characters to be input for at least two position groups, and circularly using the display format configured for the at least two position groups.

11. The apparatus according to claim 9, wherein the plurality of positions for inputting a character string are located in a user interface.

12. The apparatus according to claim 9, wherein said character string comprises a composition of a plurality of digits and/or alphabetic characters.

13. An apparatus for displaying a character string, comprising:
grouping means, for grouping a character string to be displayed into a plurality of character groups;
format configuring means, for configuring display format for every character group; and
displaying means, for displaying the character string with the configured display format.

14. The apparatus according to claim 13, wherein format configuring means and displaying means are further configured to configure display format for at least two character groups, and circularly using the display format configured for the at least two character groups.

15. The apparatus according to claim 13, wherein positions for displaying the character string are located in a user interface.

16. The apparatus according to claim 13, wherein said character string comprises a composition of a plurality of digits and/or alphabetic characters.

17. A storage medium or signal carrier, comprising instructions for carrying out a method for displaying a character string when the character string is being input, the method comprising:
a) grouping a plurality of positions for inputting characters into a plurality of position groups;
b) configuring display format for every position group for the characters to be input; and
c) responding to input of the character string, displaying the input character string with the configured display format.
